(19) United States
(12) Patent Application Publication
(10) Pub. No.: US 2003/0093880 A1
(43) Pub. Date: May 22, 2003

(54) Retractable clip assembly

(76) Inventors: Christopher Mangion, Aitleboro, MA (US); Gregor Mittersinker, Warwick, RI (US); Raul Pereira, Cumberland, RI (US)

Correspondence Address: NOTARO & MICHALOS P.C., Suite 110, 100 Dutch Hill Road, Orangeburg, NY, 10962-2100, US

(21) Appl. No.: 09/993,205

(22) Filed: Nov. 16, 2001

(51) Int. Cl. B43K 25/00

(52) U.S. Cl. 24/11 R

(57) ABSTRACT

A retractable clip assembly has a cap with a recess, a fulcrum within the cap, a clip arm mounted for movement in the recess, and a spring that lies between the cap and the clip arm. The clip arm is permanently affixed to the spring. The clip arm has a retracted position, an intermediate position, and an extended position. In the retracted position, the clip arm resides in a continuous plane with the cap profile. In the intermediate position, the front tip of the clip arm is tilted up and out of the recess via the spring pivoting against the fulcrum. In the extended position, the back end of the clip arm extends out by feeding material into the space under the clip arm.

### FIELD AND BACKGROUND OF THE INVENTION

The present invention relates generally to the field of writing instruments and in particular to retractable clips of writing instruments.

French Patent 1,086,929 discloses a writing instrument in the form of a fountain pen containing a barrel with a nib, a reservoir, etc. This writing instrument contains a top part in the form of a removable cap. The cap has a recess at its upper end for a retractable clip. The clip is supported by a spring in the interior of he cap and is pivotally mounted so that the margin of a pocket of an article of clothing, for example, can be gripped in the customary manner between the bottom end of the clip and the outer surface of the cap. For this purpose the clip is rocked at its upper end so that the lower end moves out of the cap. This operation is difficult and very easily leads the user to neglect using the clip and to keep the writing instrument disadvantageously loose in the pocket of an article of clothing. In addition there is a danger that, in grasping the bottom end of the clip, excessive pressure may be applied to the clip and cap due to the comparatively great leverage, so that damage may occur, particularly after a long period of use.

U.S. Pat. No. 3,101,075 discloses a writing instrument, having a clip made in one piece with a pushbutton. In the barrel of the writing instrument, a guide groove extending at an angle to the longitudinal axis is associated with the pushbutton. Upon actuation, the pushbutton and also the clip made in one piece therewith not only move in the direction of the longitudinal axis but also transversely of the longitudinal axis. Furthermore, a control unit comprising an upper annular element and a lower annular coupling element is provided separately from the pushbutton. By depressing the pushbutton the clip can be pushed laterally out of the barrel, and after the pushbutton is released, the margin of a pocket or the like, for example, can be gripped between the clip and the barrel. The clip is operated exclusively by means of the pushbutton. In order to retract the ink cartridge into the barrel, the tip of the ink cartridge is pressed against a hard surface, while an axially displaceable sleeve at the front end of the barrel is pushed back into the interior of the barrel. This shifts the coupling means into a rest position. To extend the ink cartridge out of the barrel, the sleeve and the tip of the ink cartridge are again pressed upon a hard surface thereby actuating coupling parts of a cam, so that the ink cartridge is shifted to the writing position. In the retracted position the tip of the cartridge is close to the front end of the writing instrument, but its distance away from it cannot be easily increased since the maximum movement of the ink cartridge is determined by the shapes of the cam and the coupling parts, and by their axial length. Furthermore, even when the cartridge is extended, the writing instrument can be fastened to an article of clothing, with the danger that the clothing may be stained by leaking writing fluid. The clip can be extended out of the barrel by actuating the pushbutton regardless of the position of the ink cartridge.

Another writing instrument is disclosed in German Patent No. DE 30 46 093, which has a clip arranged so as to be retractable into an opening in a barrel. The operating unit comprises a pushbutton and a control or operating cam for holding the cartridge in the writing position or in the position in which it is retracted into the barrel. At the upper end of the clip there is an operating head which engages the opening in the barrel on the one side, passes through the barrel, projects from the barrel on the side opposite the clip, and there has an exposed operating surface. The cartridge is extended from the barrel by pressing the pushbutton which protrudes from the upper end of the barrel, causing the clip to retract such that on the opposite side the operating head with its operating surface protrudes from the barrel. In the writing position, the pushbutton, and hence the cartridge, is held by means of a guide projection which is disposed on the operating head, and which snaps into a locking surface provided at the upper end of the cam. To retract the cartridge back into the barrel a user must act upon the operating surface to press the operating head projecting from this side of the barrel radially inwardly toward the longitudinal axis of the barrel, releasing the guide projection from the locking surface and, on the other side, shifting the clip out of the barrel. The locking surface and the guide projection are subjected to relatively great stress and wear. Arranging the cam above the end of the cartridge for the actuation of the cam creates corresponding bulk. To operate the cartridge a user must act at two different points, namely at the pushbutton at the upper end of the instrument to deploy the cartridge and at a lateral operating surface of the operating head to retract it. This makes operation inconvenient. In writing, the operating head with its operating surface protruding laterally from the barrel can be disadvantageous, and accidental retraction of the cartridge may occur when handling or putting down the writing instrument, or even while writing with it.

French Patent No. FR 22 25 298 discloses a writing instrument in which the clip is a component of the pushbutton. In this writing instrument too, when the clip is actuated, it moves both in the direction of the longitudinal axis and transversely of the longitudinal axis. No additional information is found in this disclosure about the design of a guide cam or operating cam.

German Utility Model No. DE-U 72 44 435 relates to a writing instrument having a clip and a writing part which can be deployed to a writing position and retracted to a rest position. Here the clip is disposed substantially within the circumferential limits of the barrel of the writing instrument. The writing part is deployed and retracted by means of an actuator which is configured as a pushbutton at the rearward end of the barrel. The clip is connected to the actuator by a resilient swivel connection. The clip and the actuator consist of a single piece, and the resilient swivel connection is achieved by the shaping and the elasticity of the material.

U.S. Pat. No. 5,152,626 discloses a writing instrument including a clip which can be retracted into an opening of a barrel, and an operating unit which has a pushbutton and an operating cam.

U.S. Pat. No. 5,161,906 also discloses a writing instrument having a top part which includes a movable clip and a guide portion for guiding the movement of the clip.

### SUMMARY OF THE INVENTION

It is an object of the present invention to provide an improved retractable clip for any type pf writing instrument achieving complex tilting and extension not possible with prior retractable clips.

It is a further object to provide a retractable clip that can be partially concealed within a writing instrument.

It is another object of the present invention to provide a sleek and contiguous shape for a writing instrument when a clip is not in use.

An additional object of the present invention is to provide a writing instrument with a smooth external surface, thereby preventing the writing instrument from inadvertently catching or digging on articles of clothing.

Accordingly, a writing instrument clip is provided that is held in a partially concealed position within a writing instrument cap or body, by a spring, wherein the clip pivots about a fulcrum for opening the front end of the clip to receive material between the clip and the cap so as to extend the back end of the clip away from the cap.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

In the drawings:

FIG. 1 is a sectional view of a retractable clip assembly according to the invention, in a retracted position;

FIG. 2 is a sectional view of a retractable clip assembly according to the invention, in an intermediate position;

FIG. 3 is a sectional view of a retractable clip assembly according to the invention, in an extended position; and

FIG. 4 is a side elevational view of another embodiment of the invention.

### DESCRIPTION OF THE PREFERRED EMBODIMENTS

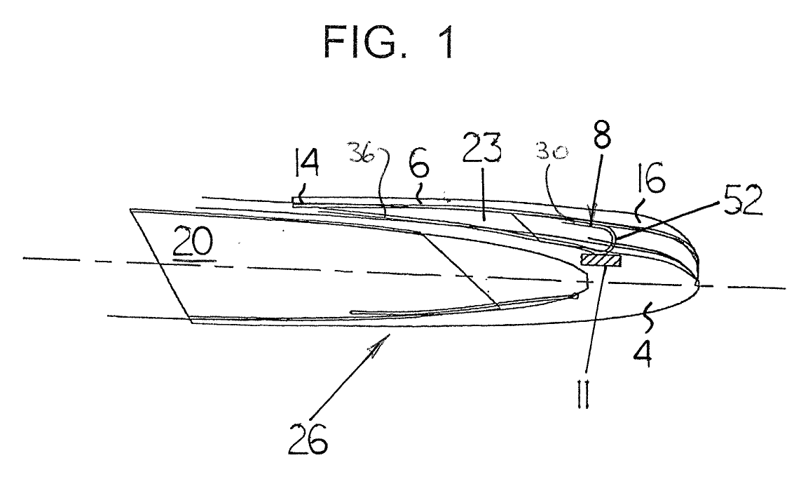

Referring now to the drawings, in which like reference numerals are used to refer to the same or similar elements, FIG. 1 shows an exemplary embodiment of the present invention in the form of a fountain pen generally designated 26 and a retractable clip assembly comprised of a pen clip arm 6, a pen cap 4, a recess 23, a fulcrum 11 and a spring 8, wherein pen clip arm 6 has a retracted position in which the clip arm is at rest. Pen clip arm 6 is partly retracted in the rest position by a spring 8, and is thereby partly concealed within a recess 23 of pen cap 4.

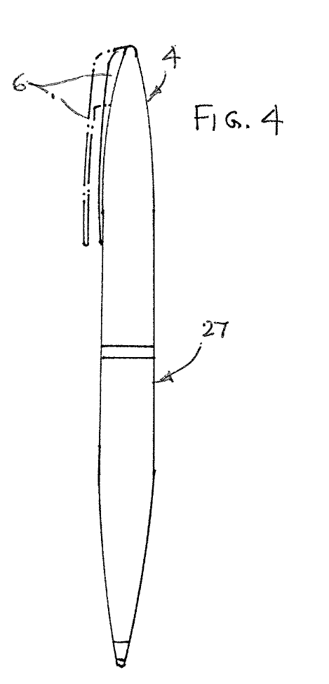

Pen cap 4 is slidably mounted over the front portion of pen body 20 of fountain pen 26. However, pen cap 4 may also be a back end of a writing instrument screwed on, slidably mounted, or otherwise permanently affixed to a pen barrel or pen body 27 as shown in FIG. 4.

Pen clip arm 6 has a front tip 14 and a back end 16, is mounted for movement in the recess 23 between various positions, and does not fall out because a part of the spring 8 that is connected to the clip arm 6 is also connected to the cap 4 in the recess 23. Pen clip arm 6 may be composed of any type of rigid material. For example, pen clip arm 6 may be composed of a polymer, synthetic, or various metals such as steel or iron that may be plated or coated with various alloys such as brass, chrome, gold, silver or tin.

Furthermore, pen clip arm 6 is not limited to use with fountain pen 26. A pen clip arm 6 may also function with other types of writing instruments used for marking such as expandable ball point pens and mechanical writing instruments such as mechanical pencils. FIG. 4 schematically illustrates such alternate instrument types. Alternatively, pen clip arm 6 may also function with writing instruments not used for marking such as styluses for Personal Digital Assistants (“PDA's”), which are generally used to point and click, and are also illustrated by FIG. 4.

A spring generally designated 8 is preferably a metallic flat spring that is bent or formed in a manner where two legs or arms extend in an opposite direction from an end portion. The end portion may be rectangular, U-shaped, V-shaped, or have some other shape that would conform and allow two legs or arms to extend in an opposite direction. Alternatively, spring 8 may also be coiled and composed of a polymer such as plastic. The top leg 30 of spring 8 is significantly shorter than a bottom leg 36, though the arms or legs 30, 36 of the spring 8 may be equally long.

The bottom leg 36 extends out of the bottom portion of the U-shaped curve 52 and is substantially straight and flat and seats against the interior wall of recess 23 in the pen cap 4 and also rests directly against the area of pen cap 4 containing fulcrum 11. The top leg 30 extends out of the top portion of the U-shaped curve 52 is also substantially straight and flat and is permanently affixed to the interior wall of pen clip arm 6. At least the end area of leg 36 is fixed to the cap 4 in recess 23 to hold the clip arm and the cap.

The spring 8 may be bent at both legs and at the U-shaped curve 52. Pen clip arm 6 is the only object coming into contact with spring 8 that will shift because it is the only object mounted for movement in recess 23. Spring 8 is not accessible via recess 23 when pen clip arm 6 is retracted because front tip 14 of pen clip arm 6 resides in a continuous plane with the pen cap 4 profile, closing off all access to cap recess 23 and anything within such as spring 8.

A fulcrum 11 is a fixed component of pen cap 4. It is also a stationary solid material. Fulcrum 11 may be shaped as a rectangle, square, cylinder, or any other shape, and may be anywhere from 1/32 to ¼ inches wide and 1/32 to ¼ inches thick. In addition, fulcrum 11 may be composed of any solid material such as a metal, wood, or polymer. Fulcrum 11 is strong enough to stop spring 8 and pivot clip arm 6 when spring 8 comes into contact with the fulcrum 11. The extent to which the clip arm pivots depends on various factors such as the elasticity and shape of the spring 8 and angle of contact.

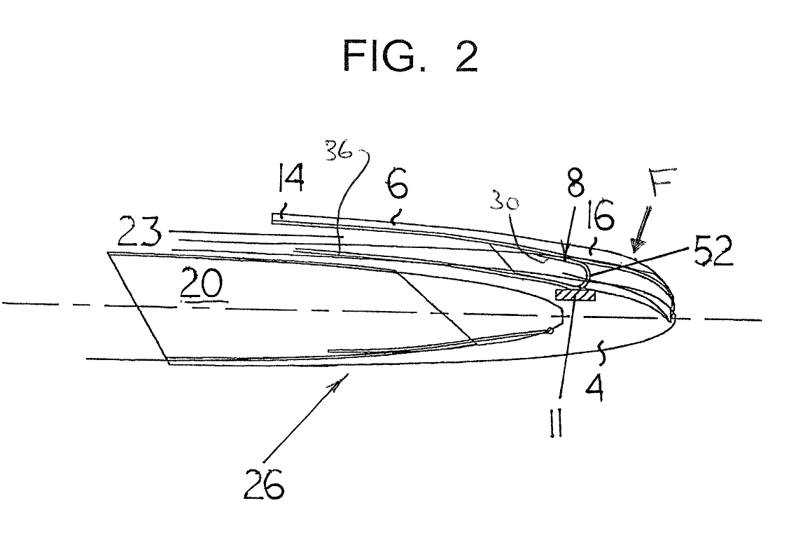

FIG. 2 is a view of the embodiment of FIG. 1, wherein pen clip arm 6 has been moved to an intermediate position in which front tip 14 is removed from the retracted position.

Spring 8 lies between pen cap 4 and pen clip arm 6 and the bottom portion of its U-shaped curve 52 rests directly against fulcrum 11 in the area of pen cap 4 since fulcrum 11 communicates with recess 23. The back end 16 of pen clip arm 6 may be depressed by a user's direct application of force in the direction of arrow F. When a user thus depresses the back end 16 of pen clip arm 6, the affixed U-shaped curve 52 is pushed against the fulcrum 11, causing the clip 6 to pivot, and thus spreading leg 30 up and away from leg 36.

Pen clip arm 6 will pivot about the fulcrum 11 based upon the force and angle of contact between the bottom portion of U-shaped curve 52 and fulcrum 11. There is enough clearance beneath the underside of the back end 16 of the pen clip arm 6 to allow enough pivoting to expose the front tip 14 above the outer surface of cap 4 and out of recess 23. Therefore, as pen clip arm 6 pivots about fulcrum 11, the front tip 14 of the pen clip arm 6 extends up and away from the body of the pen cap 4, creating a prominent and accessible opening between the cap 4 and the clip arm 6.

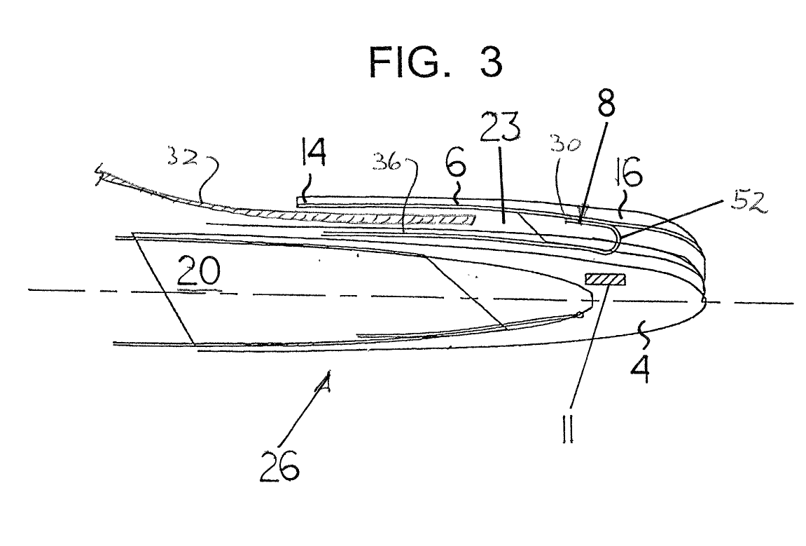

FIG. 3 is a view of fountain pen 26 and the retractable clip assembly in an extended or final position in which the back end 16 of the pen clip arm 6 is lifted out of recess 23.

Since the front tip 14 of pen clip arm 6 is extended away from the body of pen cap 4, material may be fed into the recess 23. Material 32 may consist of any type of clothing such as the fabric of a shirt pocket or sheet material such as paper sheets. As this material is fed beneath pen clip arm 6, the front end of the spring 8 will deform and the entire top of spring 8 will bend up and away from the fulcrum 11. When the back end 16 of the clip 6 is released by the user, the U-shaped curve portion 52 of spring 8 shifts to an undeformed state, causing the back end 16 to lift out of the recess 23.

FIG. 4 shows a writing instrument 27 with a cap 4 and clip arm 6 in a solid-line retracted position, and a phantom-line extended final position.

While a specific embodiment of the invention has been shown and described in detail to illustrate the application of the principles of the invention, it will be understood that the invention may be embodied otherwise without departing from such principles.

What is claimed is:

1. A retractable clip assembly for a writing instrument comprising:
a writing instrument cap with a recess;
a clip arm with a front tip and a back end, mounted for movement in the recess between a retractable position and an extended position;
a stationary fulcrum fixed within the writing instrument cap, and communicating with the recess; and
a spring having an end portion at one end with first and second legs extending toward an opposite end of the spring, the first leg fixed to the clip arm and the second leg fixed to the cap.

2. A retractable clip assembly according to claim 1, wherein the clip arm is at least partly in the recess in the extended position.

3. A retractable clip assembly according to claim 1, wherein the clip arm has an intermediate position with the front tip out of the recess.

4. A retractable clip assembly according to claim 3, wherein the fulcrum is positioned so that when the back end of the clip arm is depressed toward the recess against the spring, the spring and affixed clip arm is pressed against the fulcrum and the end portion of the spring opens.

5. A retractable clip assembly according to claim 1, wherein, with the clip arm in the extended position, the front tip is spaced from the cap for receiving material between the clip arm and the cap.

6. A retractable clip assembly according to claim 1, including a writing instrument body for engaging the cap and further comprises a marking tip connected to the body.

7. A retractable clip assembly according to claim 1, including a writing instrument body for engaging the cap and further comprises a stylus tip connected to the body.

8. A retractable clip assembly according to claim 1, wherein the fulcrum is about 1/32 to ¼ inches wide and 1/32 to ¼ inches thick.

9. A retractable clip assembly according to claim 1, wherein the first leg of the spring is shorter than the second leg.

10. A mechanism for pivoting a clip arm relative to a cap, comprising means for opening a front tip of the clip arm to receive material between the clip arm and the cap so as to extend the back end of the clip arm away from the cap.

11. A mechanism according to claim 10, including a writing instrument body accompanied by the cap and further comprises a marking tip connected to the body.

12. A mechanism according to claim 10, including a writing instrument body accompanied by the cap and further comprises a stylus tip connected to the body.

13. A mechanism according to claim 10, including a fulcrum and a spring for engaging the fulcrum forming said means.

14. A mechanism according to claim 10, wherein the spring comprising a first leg connected to the clip arm and a second leg connected to the cap and being longer than the first leg.
